(19) United States
(12) Patent Application Publication
(10) Pub. No.: US 2016/0345052 A1
(43) Pub. Date: Nov. 24, 2016

(54) METHOD AND DEVICE FOR PREVIEWING VIDEO FILES

(71) Applicant: LEMOBILE INFORMATION TECHNOLOGY (BEIJING) CO., LTD., Beijing (CN)

(72) Inventors: Xiaobin WANG, Beijing (CN); Bo LI, Beijing (CN)

(21) Appl. No.: 15/158,776

(22) Filed: May 19, 2016

(30) Foreign Application Priority Data
May 19, 2015 (CN) 201510256152.2
Jul. 13, 2015 (CN) 201510410011.1

(51) Int. Cl. H04N 21/431; H04N 21/443; H04N 21/8549; H04N 21/472; H04N 21/439

(52) U.S. Cl. CPC H04N 21/4316; H04N 21/47202; H04N 21/4396; H04N 21/8549; H04N 21/4438

(57) ABSTRACT

The present invention provides a method and a device for previewing video files. The method includes: receiving a video file previewing instruction; determining a given dynamic previewing area in response to the instruction; acquiring information of a first video file currently mapped by the dynamic previewing area from a source code of an interface to be displayed; and requesting to acquire the first video file from a resource server, and playing the first video file acquired in the dynamic previewing area when displaying the interface to be displayed. Compared with the video file previewing manner in the prior art, the present invention can display lots of information about video contents to users in the dynamic previewing area, and the users can judge whether the video file satisfies the expectations thereof based on the lots of information, so that unnecessary operations by the users are not caused, and therefore, the problems of wasting processing resources and increasing the pressure of the server will not occur.

### CROSS REFERENCE TO RELATED APPLICATION

This application is based upon and claims priority to Chinese Patent Application No. 2015102561522, filed May 19, 2015, and Chinese Patent Application No. 2015104100111, filed Jul. 13, 2015, the entire contents of which are incorporated herein by reference.

### TECHNICAL FIELD

The embodiments of the present invention relate to the field of computer technologies, and particularly, to a method and a device for previewing video files.

### BACKGROUND

At present, when a video is played through a present video player, the present video player will provide a user with picture previewing of optional videos.

For instance, when the user plays a video through the present video player, the video player, after receiving a video file previewing instruction, will provide the user with such a video previewing manner taking such video file information as the content screenshot or propaganda poster or the like of the video as a playing entrance to display, so that the user can select. When a click instruction of the user on the playing entrance is detected, the video player can play the relevant video file.

Based on the video file previewing manner provided by the prior art, the user can only know a small amount of information about the video contents. Based on the small amount of information, it may possibly cause that the user can only find that the video file played is not expected after clicking the playing entrance of the video to trigger the player to play the video file, and accordingly it is needed to click other playing entrances again. That is, the present video file previewing manner may cause unnecessary operations by the user, waste processing resources, and increase the pressure of a server.

### SUMMARY

The embodiments of the present application provide a method and a device for previewing video files for solving the problems of the present video file previewing manner which may cause unnecessary operations to the user, waste processing resources, and increase the pressure of the server.

The embodiment of the present invention provides a method for previewing video files, including:

receiving a video file previewing instruction; determining a given dynamic previewing area in response to the instruction; acquiring the information of a first video file currently mapped by the dynamic previewing area from a source code; and requesting to acquire the first video file from a resource server, and playing the first video file acquired in the dynamic previewing area when displaying the interface to be displayed.

The embodiment of the present invention also provides a device for previewing video files, including:

an instruction receiving unit configured to receive a video file previewing instruction; a dynamic previewing area determination unit configured to determine a given dynamic previewing area in response to the instruction; an information acquisition unit configured to acquire the information of a first video file currently mapped by the dynamic previewing area from a source code; and a previewing unit configured to request to acquire the first video file from a resource server, and play the first video file acquired in the dynamic previewing area when displaying the interface to be displayed.

Compared with the video file previewing manner in the prior art, the method and device for previewing video files provided by the embodiments of the present invention can display lots of information about video contents to users in the dynamic previewing area, and the users can judge whether the video file satisfies the expectations thereof based on the lots of information, so that unnecessary operations of the users are avoided, and therefore, the problems of wasting resources and increasing the pressure of the server will not occur.

### BRIEF DESCRIPTION OF THE DRAWINGS

In order to explain the technical solutions in the embodiments of the invention or in the prior art more clearly, the drawings used in the descriptions of the embodiments or the prior art will be simply introduced hereinafter. It is apparent that the drawings described hereinafter are some embodiments of the invention, and those skilled in the art may also obtain other drawings according to these drawings without going through creative work.

FIG. 1 is a schematic diagram of a concrete implementation flow of a method for previewing video files provided by the embodiment of the present invention;

FIG. 1a is a display diagram of a relevant interface of a video player provided by the embodiment of the present invention;

FIG. 1b is a display diagram of the relevant interface of the video player provided by the embodiment of the present invention;

FIG. 1c is a display diagram of the relevant interface of the video player provided by the embodiment of the present invention;

FIG. 1d is a schematic diagram of a first display subarea and a second display subarea in the embodiment of the present invention;

FIG. 1e is a display diagram of the relevant interface of the video player provided by the embodiment of the present invention;

FIG. 1f(1) is a display diagram of the relevant interface of the video player provided by the embodiment of the present invention;

FIG. 1f(2) is a display diagram of the relevant interface of the video player provided by the embodiment of the present invention;

FIG. 1g is a display diagram of an initial interface of the video player provided by the embodiment of the present invention;

FIG. 1h is a display diagram of an intermediate interface of a first touch gesture detected on the basis of an electronic terminal in FIG. 1g provided by the embodiment of the present invention;

FIG. 1i is a display diagram of an ending interface of the first touch gesture detected on the basis of the electronic terminal in FIG. 1g provided by the embodiment of the present invention;

FIG. 1j is a display diagram of another relevant interface of the video player provided by the embodiment of the present invention; and

FIG. 2 is a schematic diagram of a concrete structure of a device for previewing video files provided by the embodiment of the present invention.

### DETAILED DESCRIPTION

To make the objects, technical solutions and advantages of the present application more clearly, the technical solutions of the present application will be clearly and completely described hereinafter with reference to the embodiments and relevant drawings of the present application. Apparently, the embodiments described are merely partial embodiments of the present application, rather than all embodiments. Other embodiments obtained by those having ordinary skills in the art on the basis of the embodiments of the present application without going through creative efforts shall all fall within the protection scope of the present application.

The technical solutions provided by each embodiment of the present application will be described in details with reference to the drawings hereinafter.

### Embodiment 1

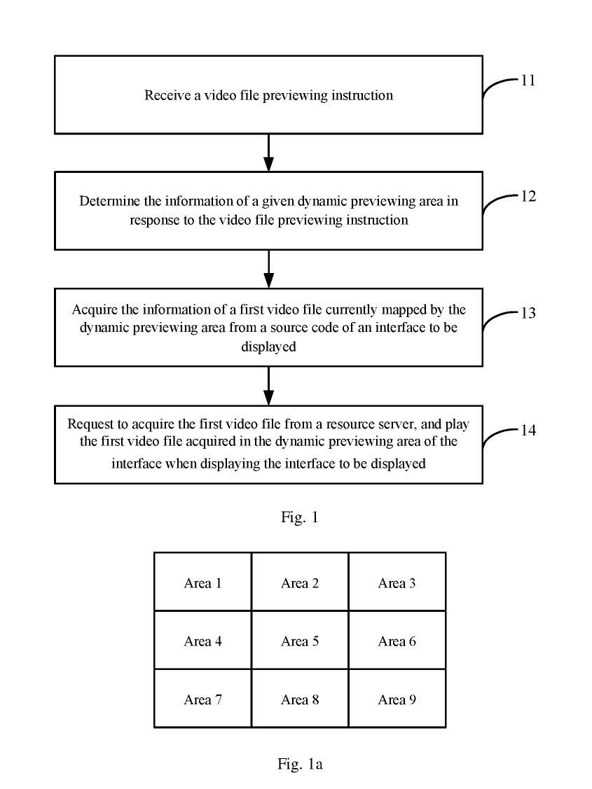

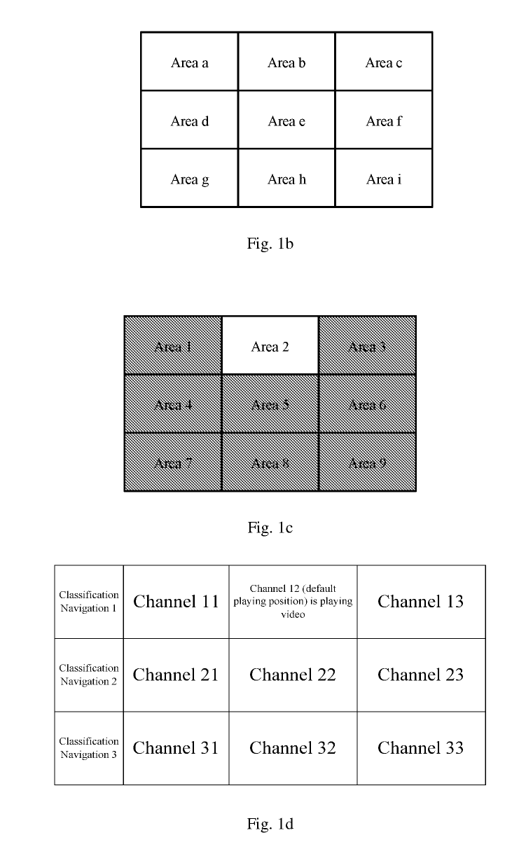

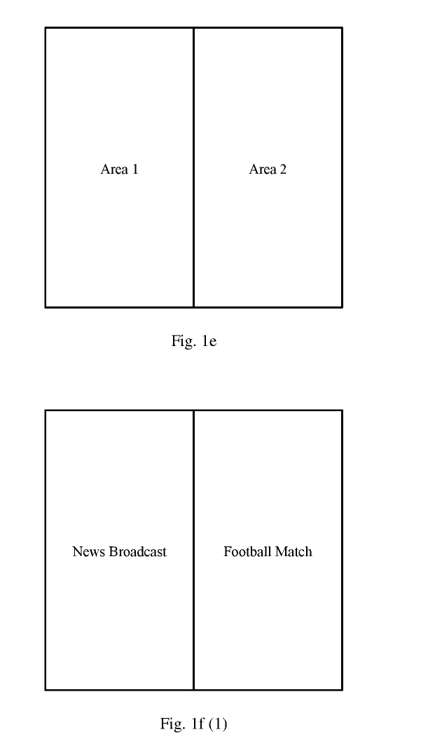

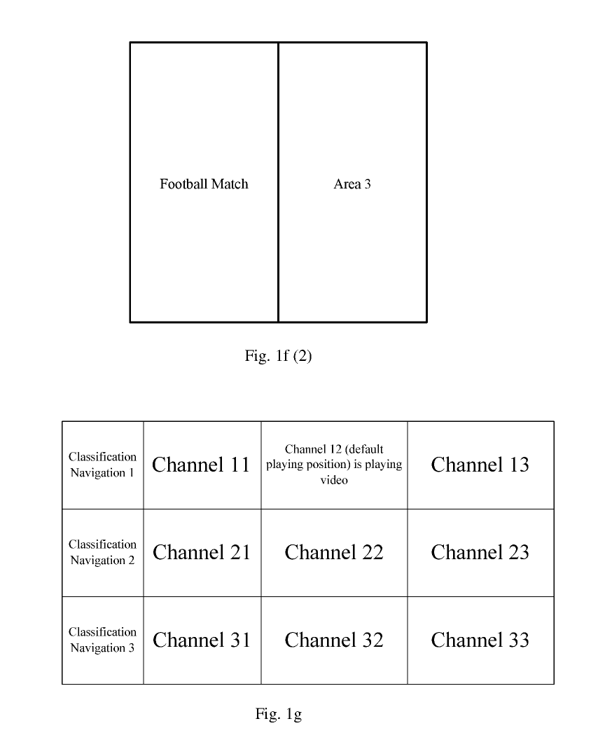

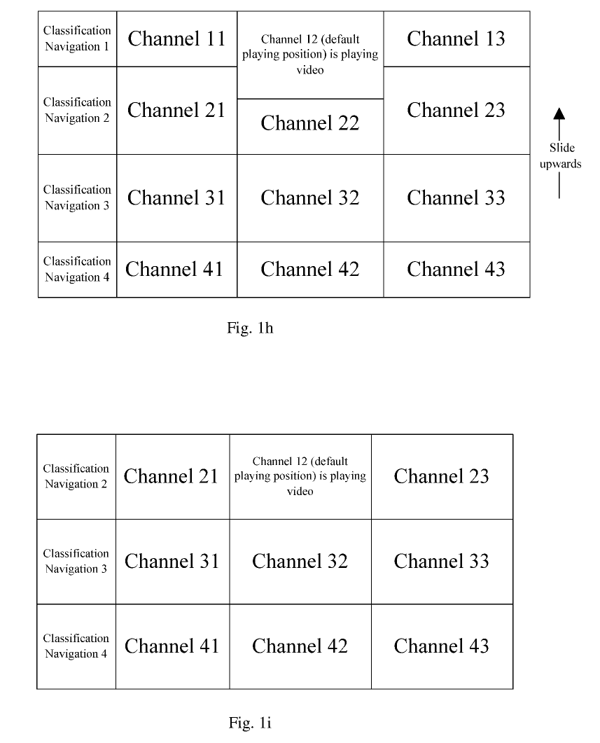

The embodiment of the present invention provides a method for previewing video files for solving the problems of the present video file previewing manner which may cause unnecessary operations by the user, waste processing resources, and increase the pressure of the server. The schematic diagram of the concrete implementation flow of the method is as shown in FIG. 1, wherein the method mainly includes the following steps.

In step 11, a video file previewing instruction is received.

The embodiment is applied to an electronic terminal, wherein the electronic terminal may be a mobile phone, a PAD, a PC/tablet or the like. The method for previewing videos provided by the embodiment can be concretely applied to a video application that is installed in the foregoing electronic terminal.

Wherein, the video previewing instruction is triggered by a user through performing operations (such operations as slide, click, etc.) on a video operation interface. The video file previewing instruction may be, but is not limited to a video website opening instruction, or an instruction for opening a video player, or the like.

In an implementation manner, the video file includes: live telecast videos and an on-demand videos; for instance, live videos like live athletic contest, variety show, vocal concert, etc. as well as on-demand videos like cartoon, teleplay, movie, etc.

The video file previewing instruction can be inputted into an apparatus through an information input device of the apparatus usually, wherein the information input device mentioned herein may be any one or more of a touch screen, a mouse, a physical keyboard, or the like.

In step 12, the information of a given dynamic previewing area is determined in response to the video file previewing instruction.

Taking an executive body of the method being a video playing APP for example, generally, in order to show an interface pushed by a server, the APP will request to acquire a source code of the interface from the server.

The source code of the interface pushed by the server to the APP may include the information of the dynamic previewing area. The information generally includes the size of the area and the position in the interface. According to the information, the APP can implement to uniquely position a dynamic previewing area from the interface. The dynamic previewing area can be sequentially used to play a previewed video file, so as to provide lots of information of the video contents to users.

In order to enable the APP to distinguish the information of the dynamic previewing area from the information of other areas, the information of the dynamic previewing area may usually include some special identities that are used for uniquely representing the type of the dynamic previewing area.

In an implementation manner, in order to facilitate the users to set the dynamic previewing area according to different habits, the embodiment of the present application also supports the user to set the dynamic previewing area. The concrete implementation manner is as follows: a previewing area setting instruction which includes the information of the interface area and is inputted by the user is acquired before determining the given dynamic previewing area in response to the video file previewing instruction, and the information of the interface area in the instruction is saved. Based on the information of the interface area saved, when receiving a video file previewing instruction subsequently, the given dynamic previewing area can be determined according to the information of the interface area saved in response to the instruction. It should be illustrated that the information of the interface area mentioned herein usually includes the size information and position information of the area.

The following illustrates how to set the dynamic previewing area by the user.

Taking a video player installed on a mobile phone for instance, the user may trigger the video player to show areas to be selected as shown in FIG. 1a through clicking an interface setting option provided by the video player. It is provided that the user wants to set the area 2 as the dynamic previewing area at this moment, the user can perform a specific operation (such operations as “long press”, “click”, “slide” or the like) on the area 2 so as to trigger a previewing area setting instruction; after acquiring the setting instruction, the video player saves the position information and size information of the area 2 included in the setting instruction. Based on these information saved, when acquiring the video file previewing instruction of the user subsequently, these information saved as the information of the dynamic previewing area is just acquired.

In an implementation manner, if the user wants to preview a plurality of video files at the same time, in order to satisfy the demand of the user, the method provided by the embodiment of the present application may also include: acquiring at least one previewing area setting instructions inputted by the user, and saving the information of the interface area respectively included in the previewing area setting instructions acquired. Then, the information of two interface areas serving as the information of the dynamic previewing areas can be acquired subsequently in response to the video file previewing instructions.

The following illustrates how to set a plurality of dynamic previewing areas by the user.

Taking a video player installed on a mobile phone for instance, the user may trigger the video player to show areas to be selected as shown in FIG. 1b through clicking an interface setting option provided by the video player. It is provided that the user expects to preview video files on the area a, the area b and the area c, the user can perform a specific operation (such operations as “long press”, “click”, “slide” or the like) on the above areas so as to trigger a previewing area setting instruction; the video player acquires the setting instruction, and saves the information of the interface areas of the area a, the area b and the area c included in the setting instruction. At this moment, when the video file previewing instruction of the user is acquired, the area a, the area b and the area c are used as the given dynamic previewing areas according to the information of the interface areas saved.

It should be illustrated that the dynamic previewing area in the embodiment of the present invention is an area which displays the contents of video files using a dynamic previewing manner (such as playing). In an implementation manner, the interface, besides may including the dynamic previewing area, may also include a static previewing area. Wherein, the static previewing area is an area which displays the contents of video files using a static previewing manner (such as displaying the poster of the video files).

The static previewing area may also be determined in response to the video file previewing instruction. In the embodiment of the present invention, the manner of determining the static previewing area is similar to said manner of determining the dynamic previewing area above, and will not be elaborated herein.

In the embodiment of the present invention, the dynamic previewing area and the static previewing area can be arranged in a “Sudoku” manner For instance, taking the video player installed on the mobile phone for example still, the dynamic previewing area and the static previewing area as shown in FIG. 1c are determined in response to the video file previewing instruction. In FIG. 1c, the area 2 is the given dynamic previewing area, and other areas excluding the area 2 are static previewing areas.

In the embodiment of the present invention, the static previewing area can either be set by the server or be set by the user. The manner of setting the static previewing area by the user is similar to the foregoing manner of setting the dynamic previewing area by the user, and will not be elaborated herein.

Taking the method for previewing video files provided by the embodiment applied to an electronic terminal for example, a show interface of the electronic terminal may include at least one classification video show area, the classification video show area includes a first show subarea and at least one second show subarea, the first show subarea is configured to show a video classification identity, the second show subarea is configured to show a video previewing window, and the video previewing window is configured to show video information corresponding to the video in the video classification. The second show subarea mentioned herein is namely the “Sudoku” formed by the dynamic previewing area and the static previewing areas above.

For example, as shown in FIG. 1d, the areas where a classification navigation 1 to a classification navigation 3 are located are namely the first show subareas; the areas where the nine channels in the figure are located are namely the second show subareas; and the show area corresponding to the position of the channel 12 is the dynamic previewing area.

In step 13, the information of the video file currently mapped by the information of the dynamic previewing area is acquired from the source code of the interface to be displayed.

It should be illustrated that, in order to distinctively describe different video files, the video file mentioned herein can be called as a first video file.

In the embodiment of the present invention, the source code of the interface to be displayed provided by the server may include a mapping relationship between various information of the interface area (which are position information and size information usually) and file information (which may possibly be the information of the video file, picture information, text information, or the like). Then, after the information of the dynamic previewing area is determined through performing step 12, the file information mapped by the information of the dynamic previewing area can be just determined according to the information of the dynamic previewing area as well as the mapping relationship between various information of the interface area included in the source code and the file information.

For instance, the source code of an interface to be displayed provided by the server may include such a mapping relationship “the size is 100×100, the position in an interface coordinate system is position 1′, mapping to a video streaming address 1”. Then, the information of the dynamic previewing area given by the server and determined through performing step 11 is that “the size is 100×100, and the position in the interface coordinate system is position 1”, or the information of the dynamic previewing area given by the user and determined through performing step 11 is that “the size is 100×100, and the position in the interface coordinate system is position 1”; then, according to the foregoing mapping relationship, it can be determined that the information of the first video file mapped to the information of the dynamic previewing area is the video streaming address 1.

Wherein, the information of the first video file currently mapped by the dynamic previewing area acquired may include, but is not limited to such information of the video streaming address of the first video file or the like that represents the position of the first video file.

In step 14, a first video file is requested to be acquired from the resource server according to the information of the first video file (such as the video streaming address of the video file), and the first video file acquired is played in the dynamic previewing area determined according to the information of the dynamic previewing area when displaying an interface to be displayed.

In an implementation manner, in order to be capable of playing the first video file acquired in the dynamic previewing area of the interface, a video playing control can be loaded in the interface where the dynamic previewing area is located. Then, the concrete implementation manner for playing the first video file acquired in the dynamic previewing area of the interface may be: playing the first video file acquired through the video playing control.

For example, if the user determines that the given dynamic previewing area is the area a through the step 11 and the step 12, then the video playing control is loaded in the interface where the area a is located, and the video file acquired through the step 13 and the step 14 will be played through the video playing control loaded at the moment.

In an implementation manner, when the user wants to switch the video file played in the dynamic previewing area, the method of the embodiment of the present application as shown in FIG. 1 may further include the steps of: receiving a video file previewing switching instruction; updating the information of the video file in the source code of the interface mapped by the dynamic previewing area in response to the video file previewing switching instruction; requesting to acquire the video file currently mapped by the dynamic previewing area from the resource server after the updating is completed, and playing the video file acquired in the dynamic previewing area.

The video file previewing switching instruction mentioned herein may be triggered by the user through performing a specific operation (such operations as “slide upwards”, “slide downwards”, “slide to the left” and “slide to the right”, or the like) on the relevant interface of the video player.

For example, as shown in FIG. 1f(1), it is provided that the video presently played in the dynamic previewing area is “News Broadcast”; at this moment, the user wants to watch a video “Football Match” in the right of the dynamic previewing area, the user moves the video “Football Match” to the dynamic previewing area by “slide to the left”. As shown in FIG. 1f(2), then the video “Football Match” is played in the dynamic previewing area at the moment.

In an implementation manner, if two dynamic previewing areas are acquired through performing the step 12, and the information of the first video file respectively mapped by the two dynamic previewing areas are determined through performing step 13, the relevant first video files can be respectively acquired direct at the two dynamic previewing areas when performing step 14. For instance, a first video file 1 is acquired direct at the dynamic previewing area 1; and a first video file 2 is acquired direct at the dynamic previewing area 2.

The method provided by the embodiment of the present invention may also include: acquiring an audio parameter of the first video file (the audio parameter is configured to represent whether the first video file is played in the dynamic previewing area in mute); when the audio parameter acquired is configured to represent that the first video file is played in the dynamic previewing area in mute, playing the first video file according to a mute mode in the dynamic previewing area of the interface; and when the audio parameter acquired is configured to represent that the first video file is not played in the dynamic previewing area in mute, playing the first video file according to an un-mute mode in the dynamic previewing area of the interface.

Employing the manner of “playing the first video file according to a mute mode in the dynamic previewing area of the interface” can avoid the problem of mutual interference caused by playing different video files in a plurality of dynamic previewing areas at the same time.

Wherein, the audio parameter mentioned herein can be independently set by the user. When there are at least two dynamic previewing areas, the user can set different audio parameters for different dynamic previewing areas.

Based on the different audio parameters set for different dynamic previewing areas, it is realized that partial video files can be played using a mute mode, and a certain video file can be played using a un-mute mode. For example, it is provided that the area 2 and the area 5 are the given dynamic previewing areas determined through performing step 12; if the video played in the area 2 is the video expected to play by the user at this moment, in order to avoid the sound of the video previewed and played in the area 5 from affecting the user to watch the video previewed and played in the area 2, the video player will acquire the audio parameter of the video file currently mapped by the dynamic previewing area 5 which is triggered and transmitted by the user through performing a specific operation (such operations like “long press”, “click”, “slide” or the like) on the area 5, wherein the audio parameter acquired represents that the video file is played in the dynamic previewing area 5 in mute. Then, the video file mapped by the dynamic previewing area 5 is played in the dynamic previewing area 5 in mute.

For instance, the dynamic previewing area A is playing a basketball match, and the dynamic previewing area B is playing a news program. At this moment, the user wants to watch the news program, and also wants to watch the score of the basketball match at the same time, and then the user can set the basketball match to be played in the dynamic previewing area A in mute.

In an implementation manner, in order to display the static information of the video file using the static previewing area, the information of the video file mapped by the information of the static previewing area can be acquired from the source code of the interface to be displayed. The information of the video file mapped by the information of the static previewing area can be called as the information of a second video file. The information of the second video file is generally the data content information of the second video file, for instance, the name, brief introduction, poster or stage photo of the second video file, or the like. Since the manner of acquiring the information of the second video file from the source code of the interface to be displayed is similar to the manner of acquiring the first video file from the source code, it will not be elaborated herein.

After the information of the second video file mapped by the information of the static previewing area is acquired and after the first video file is acquired, the interface to be displayed can be displayed. The concrete display manner may include “playing the first video file acquired in the dynamic previewing area” and “displaying the information of the second video file in the static area”. For example, as shown in FIG. 1e, the area 1 is a dynamic previewing area, and the area 2 is a static previewing area, then the first video file mapped by the area 1 is played in the area 1; and the data information of the second video file like the name of the video and the content thumbnail of the video or the like mapped by the area 2 is displayed in the area 2.

Taking the method for previewing video files provided by the embodiment applied to an electronic terminal for example, if it is as described above, an show interface of the electronic terminal may include at least one classification video show area, the classification video show area includes a first show subarea and at least one second show subarea, the first show subarea is configured to show a video classification identity, the second show subarea is configured to show a video previewing window, and the video previewing window is configured to show video information corresponding to the video in the video classification. The second show subarea mentioned herein is namely the “Sudoku” formed by the dynamic previewing area and the static previewing areas above.

When the position of a certain second show subarea is a default playing position (i.e., the dynamic previewing area), a video playing control can be loaded at the video previewing window showed by the second show subarea so that the control can be utilized, wherein the corresponding video data is acquired, loaded and played at the video previewing window. The videos mentioned in the embodiment can either be live videos or on-demand videos. Please refer to FIG. 1g for the default playing position , wherein the video classification identities are the classification navigation 1, the classification navigation 2, the classification navigation 3, or the like; the position where the channel 12 is located is namely the default playing position, and the corresponding area thereof is the dynamic previewing area, so that the video playing control can be loaded in the dynamic previewing area, so as to load and play the corresponding video data at the default playing position. When entering the interface as shown in FIG. 1g, the electronic terminal judges whether the default playing position has a video previewing window. If yes, a video view floating layer for playing is transferred in the dynamic previewing area, and the video view floating layer for playing is utilized to play the video data of the channel 12.

When the electronic terminal detects a first touch gesture, the show interface of the electronic terminal is moved according to the direction of the first touch gesture; meanwhile, the position and the playing contents of the videoview floating layer for playing are controlled to be unchanged. As shown in FIG. 1h for details, the direction of the first touch gesture is from bottom to top, each video classification identity and each video previewing window are slid synchronously according to the direction of the first touch gesture, but the position and the playing contents of the video view floating layer for playing are not slid; as shown in FIG. 1i, a channel corresponding to the default playing position is actually a video previewing window of the channel 22. However, the electronic terminal is still playing the video corresponding to the channel 12 at this moment.

When the electronic terminal monitors a switching instruction for switching the current task (video previewing task) and enters the “video previewing task” again, the electronic terminal will reconfirm whether the default playing position has a video previewing window. If yes, a video view floating layer for playing is transferred at the default playing position, and the video data of the channel 22 corresponding to the default playing position is acquired from the resource server, so that the video data of the channel 22 is played in the video view floating layer for playing, which is as shown in FIG. 1j. In a practical application scenario, as long as such operations like re-opening and refreshing or the like are performed on any interface provided by FIGS. 1g-1i, the electronic terminal will reconfirm whether the dynamic previewing area corresponding to the default playing position has the video previewing window.

Moreover, the setting of the default playing position can be implemented in the embodiment through the following manner The electronic terminal monitors a dragging instruction direct at the video view floating layer for playing, and drags the videoview floating layer for playing to a new default playing position according to the dragging instruction. The electronic terminal records the default playing position, and will reconfirm whether a dynamic previewing area corresponding to the new default playing position has the video previewing window when monitoring the switching instruction for switching the current task (video previewing task) and entering the “video previewing task” again. The electronic terminal will also transmit the new default playing position recorded to the resource server for storage when the video previewing task is completed, so that the electronic terminal can perform the above video previewing process according to the new default playing position when opening the video previewing task again.

In the embodiment, it may be set to employ the video previewing method only for some videos in specific types, for example, the video previewing method can be only employed on those videos with real-time changed contents like live telecast, carousel, satellite television program, or the like. When the video is a live video, then the video classification identity can be a channel classification identity, and the video previewing window is a channel show window, and the channel show window is configured to show the channel information corresponding to the channel at the channel classification.

The embodiment may be applied to an electronic terminal, wherein the electronic terminal may be a mobile phone, a PAD, a PC/tablet or the like. The method for previewing videos provided by the embodiment can be concretely applied to a video application that is installed in the foregoing electronic terminal. The video application can either be a video application (such as a live telecast application) of the foregoing specific type, or be a video application (such as LeTV Video application) of an integrated type, or the like. If the video application is a video application of a specific type, the homepage of the video application can be set as a video previewing interface; therefore, the needs to enter the video previewing interface is determined when receiving an instruction of enabling the video application. If the video application is a video application of an integrated type, the page of the channel corresponding to the foregoing channel of a specific type (such as a live channel, a carousel channel, or the like) of the video application can be set as a video previewing interface; therefore, the needs to enter the video previewing interface is determined when receiving an instruction of jumping to the channel of a specific type of the video application.

Compared with the video file previewing manner in the prior art, the device for previewing video files provided by the embodiment of the present invention can display lots of information about video contents to users in the dynamic previewing area, and the users can judge whether the video file satisfies the expectations thereof based on the lots of information, so that unnecessary operations by the users are not caused, and therefore, the problems of wasting resources and increasing the pressure of the server will not occur.

It should be illustrated that the executive bodies of each step of the method provided by the embodiment 1 can all be the same apparatus, or different apparatuses serve in the method as the executive bodies as well.

### Embodiment 2

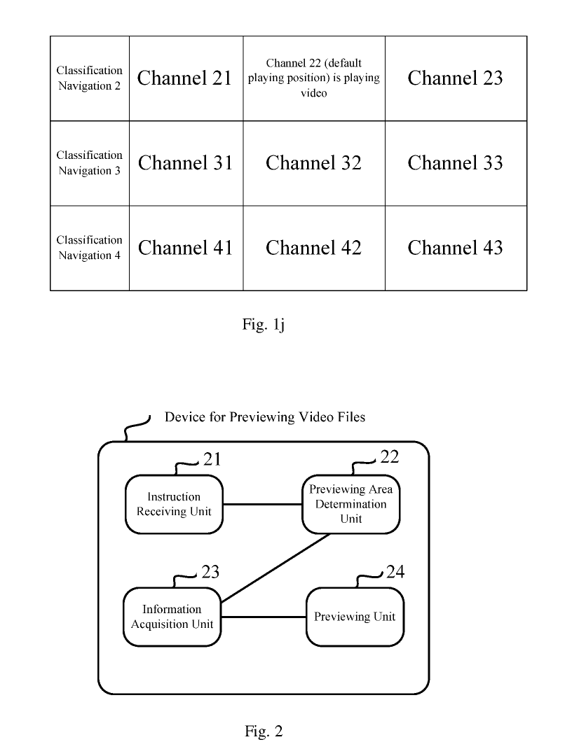

The embodiment of the present application provides a device for previewing video files for solving the problems of the present video file previewing manner which may cause unnecessary operations by the user, waste processing resources, and increase the pressure of the server. The schematic diagram of the concrete implementation flow of the device is as shown in FIG. 2, wherein the device includes an instruction receiving unit 21, a dynamic previewing area determination unit 22, an information acquisition unit 23 and a previewing unit 24.

Wherein, the instruction receiving unit 21 is configured to receive a video file previewing instruction;

the dynamic previewing area determination unit 22 is configured to determine the information of a given dynamic previewing area in response to the instruction;

the information acquisition unit 23 is configured to acquire the information of a first video file currently mapped by the information of the dynamic previewing area from a source code of an interface to be displayed; and

the previewing unit 24 is configured to request to acquire the first video file from a resource server, and play the first video file acquired in the dynamic previewing area when displaying the interface to be displayed.

In an implementation manner, the dynamic previewing area determination unit 22 is configured to acquire a previewing area setting instruction inputted by a user, the previewing area setting instruction including information of an interface area; save the information of the interface area; and determine the given dynamic previewing area according to the information of the interface area saved in response to the video file previewing instruction.

In an implementation manner, the information acquisition unit 23 is also configured to acquire an audio parameter of the first video file, wherein the audio parameter is configured to represent whether the first video file is played in the dynamic previewing area in mute. When the audio parameter acquired by the information acquisition unit 23 is configured to represent that the first video file is played in the dynamic previewing area in mute, the previewing unit 24 is configured to play the first video file according to a mute mode in the dynamic previewing area of the interface; and when the audio parameter acquired by the information acquisition unit 23 is configured to represent that the first video file is not played in the dynamic previewing area in mute, then the previewing unit 24 is configured to play the first video file according to an un-mute mode in the dynamic previewing area of the interface.

In an implementation manner, the previewing unit 24 is configured to load a video playing control in the interface where the dynamic previewing area is located; and play the first video file acquired through the video playing control.

In an implementation manner, the device further includes: a previewing area switching unit configured to receive a video file previewing switching instruction after the previewing unit 24 plays the first video file acquired in the dynamic previewing area of the interface; update the information of the video file mapped by the dynamic previewing area in response to the instruction; and request to acquire the information of the video file mapped from the resource server, and play the video file mapped in the dynamic previewing area.

In an implementation manner, the device further includes: a static previewing area determination unit configured to determine a static previewing area; acquire the information of a second video file currently mapped by the information of the static previewing area from the source code; and display the static information of the second video file in the static previewing area of the interface.

In the embodiment of the present invention, the static information of the second video file may include, but is not limited to: the data content information of the second video file; and the information of the first video file may include, but is not limited to: the video streaming address information of the first video file.

Compared with the video file previewing manner in the prior art, the device for previewing video files provided by the embodiment of the present invention can display lots of information about video contents to users in the dynamic previewing area, and the users can judge whether the video file satisfies the expectations thereof based on the lots of information, so that unnecessary operations by the users arenot caused, and therefore, the problems of wasting resources and increasing the pressure of the server will not occur.

Related functional modules above of the embodiment of the present invention can be implemented through a hardware processor.

The device embodiments described above are only exemplary, wherein the units illustrated as separation parts may either be or not physically separated, and the parts showed as units may either be or not physical units, i.e., the parts may either be located in the sameplace, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art, may be implemented in the form of a software product. The computer software product may be stored in a computer-readable storage medium such as a ROM/RAM, a diskette, an optical disk or the like, and includes several instructions for instructing a computer apparatus(which may be a personal computer, a server, or a network apparatus so on) to execute the method according to each embodiment or some parts of the embodiments.

It should be finally noted that the above embodiments are only configured to explain the technical solutions of the present invention, but are not intended to limit the present invention. Although the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the relevant technical solutions to depart from the spirit and scope of the claims.

It should be appreciated by those skilled in this art that the embodiments of the present invention can be provided as a method, a system or a computer program product. Therefore, the embodiments of the present invention may be realized by complete hardware embodiments, complete software embodiments, or software-hardware combined embodiments. Moreover, the present invention may be realized in the form of a computer program product that is applied to one or more computer-usable storage mediums (including, but not limited to disk memory, CD-ROM or optical memory) in which computer-usable program codes are contained.

The present invention is illustrated with reference to the flow chart and/or the block diagram of the method, apparatus (system) and computer program product according to the embodiments of the present invention. It should be appreciated that each flow in the flow chart and/or each block in the block diagram and/or the combination of the flows in the flow chart and the blocks in the block diagram may be realized by computer program instructions. These computer program instructions may be provided to a general-purpose computer, a special purpose computer, an embedded processor or processors of other programmable data processing devices to generate a machine which makes the instructions executed by the processors of the computers or the processors of other programmable data processing devices to generate a device for realizing the functions specified in one or more flows of the flow chart and/or one or more blocks in the block diagram.

These computer program instructions may also be stored in a computer-readable memory which is capable of guiding a computer or another programmable data processing device to work in a given manner, thereby enabling the instructions stored in the computer-readable memory to generate a product including an instruction device for realizing the functions specified in one or more flows of the flow chart and/or one or more blocks in the block diagram.

These computer program instructions may also be loaded to a computer or other programmable data processing apparatuses, to execute a series of operations thereon to generate the processing realized by the computer, so that the instructions executed by the computer or other programmable data apparatuses offer the steps for realizing the functions specified in one or more flows of the flow chart and/or one or more blocks in the block diagram.

In a typical configuration, a computing apparatus includes one or more processors (CPU), input/output interface(s), network interface(s) and a memory.

The memory may include such forms as a volatile memory, a random access memory (RAM) and/or a non-volatile memory in a computer-readable medium, such as a read-only memory (ROM) or a flash memory (flash RAM). The memory is an example of the computer-readable medium.

The computer-readable medium includes nonvolatile and volatile as well as movable and immovable medium, which can implement information storage through any method or technology. The information may be a computer-readable instruction, a data structure, a program module, or other data. The examples of the computer storage medium include, but are not limited to a phase change memory (PRAM), a static random access memory (SRAM), a dynamic random access memory (DRAM), other type random access memory (RAM), a read-only memory (ROM), an electrically erasable programmable read-only memory (EEPROM), a flash memory or other memory technology, a compact disk read-numeral only memory (CD-ROM), a digital versatile disk (DVD) or other optical storage and videocassette, magnetic tape, disk storage or other magnetic storage device or any other non-transmission medium, which can be configured to store information that can be accessed by the computing device. According to the definition herein, the computer-readable medium does not include a transitory computer-readable media (transitory media), such as modulated data signal and carrier wave.

It should be illustrated that the terms “include”, “comprise” or any variation thereof herein refer to “include but not limited to”. Therefore, in the context of a process, method, object or apparatus that includes a series of elements, the process, method, commodity or device not only includes such elements, but also includes other elements not specified expressly, or may include inherent elements of the process, method, commodity or apparatus. Unless otherwise specified, in the context of “include a . . . ”, the process, method, commodity or apparatus that includes or comprises the specified elements may also include other identical elements.

It should be appreciated by those skilled in this art that the embodiments of the present application can be provided as a method, a system or a computer program product. Therefore, the embodiments of the present application may be realized by complete hardware embodiments, complete software embodiments, or software-hardware combined embodiments. Moreover, the present application may be realized in the form of a computer program product that is applied to one or more computer-usable storage mediums (including, but not limited to disk memory, CD-ROM or optical memory) in which computer-usable program codes are contained.

The above descriptions are merely embodiment of the present application, but are not intended to limit the present application. Other alterations and changes of the present application will be apparent for those skilled in the art. Any modification, equivalent replacement, improvement and the like, made within the spirit and principle of the present application, shall all fall within the scope of the claims of the present application.

1. A method for previewing video files, comprising:
receiving a video file previewing instruction;
determining information of a given dynamic previewing area in response to the instruction;
acquiring information of a first video file currently mapped by the information of the dynamic previewing area from a source code of an interface to be displayed; and
requesting to acquire the first video file from a resource server, and playing the first video file acquired in the dynamic previewing area when displaying the interface to be displayed.

2. The method according to claim 1, wherein the method, before determining the information of the given dynamic previewing area in response to the instruction, further comprises:
acquiring a previewing area setting instruction inputted by a user, the previewing area setting instruction comprising the information of an interface area;
saving the information of the interface area; then,
determining the information of the given dynamic previewing area in response to the video file previewing instruction comprising:
determining the information of the given dynamic previewing area according to the information of the interface area saved in response to the video file previewing instruction.

3. The method according to claim 2, further comprising:
acquiring an audio parameter of the first video file, wherein the audio parameter is configured to represent whether the first video file is played in the dynamic previewing area in mute; then,
playing the first video file acquired in the dynamic previewing area when displaying the interface to be displayed comprising:
when the audio parameter acquired is configured to represent that the first video file is played in the dynamic previewing area in mute, playing the first video file according to a mute mode in the dynamic previewing area of the interface; and
when the audio parameter acquired is configured to represent that the first video file is not played in the dynamic previewing area in mute, playing the first video file according to an un-mute mode in the dynamic previewing area of the interface.

4. The method according to claim 1, further comprising:
loading a video playing control in the interface where the dynamic previewing area is located; then,
playing the first video file acquired in the dynamic previewing area of the interface comprising:
playing the first video file acquired in the dynamic previewing area of the interface through the video playing control.

5. The method according to claim 1, wherein the method, after playing the first video file acquired in the dynamic previewing area of the interface, further comprises:
receiving a video file previewing switching instruction;
updating the information of the video file mapped by the dynamic previewing area in response to the instruction; and
requesting to acquire the information of the video file mapped from the resource server, and playing the video file mapped in the dynamic previewing area.

6. The method according to claim 1, further comprising:
determining information of a static previewing area;
acquiring information of a second video file currently mapped by the information of the static previewing area from the source code; and
displaying the static information of the second video file in the static previewing area of the interface.

7. The method according to claim 6, wherein the static information of the second video file comprises: the data content information of the second video file; and
the information of the first video file comprises: the video streaming address information of the first video file.

8. A method for previewing video files, applied to an electronic terminal, wherein an show interface of the electronic terminal comprises at least one classification video show area, the classification video show area comprises a first show subarea and at least one second show subarea, the first show subarea is configured to show a video classification identity, the second show subarea is configured to show a video previewing window, and the video previewing window is configured to show video information corresponding to the video in the video classification; and the method for previewing video files comprises:
acquiring a previewing and playing position corresponding to a dynamic previewing area, and judging whether the previewing and playing position has a second show subarea; and
if the previewing and playing position is judged to have the second display subarea, playing a target video in a previewing and playing window loaded at the previewing and playing position, wherein the target video is the video information corresponding to the second show subarea located at the previewing and playing position.

9. The method for previewing video files according to claim 8, wherein the method, before acquiring the previewing and playing position corresponding to the dynamic previewing area, further comprises:
monitoring a switching instruction for switching to a video previewing task.

10. The method for previewing video files according to claim 8, further comprising:
when a dragging instruction for moving the previewing and playing window is detected, moving the previewing and playing window according to the dragging instruction; and
recording the position of the previewing and playing window when the moving is ended as a target playing position, and setting the target playing position as the previewing and playing position.

11. The method for previewing video files according to claim 8, further comprising:
acquiring an audio parameter of the target video, wherein the audio parameter is configured to represent whether the target video is played in the previewing and playing window in mute;
then, playing the target video in the previewing and playing window loaded at the previewing and playing position comprising:
when the audio parameter acquired is configured to represent that the target video is played in the previewing and playing window in mute, playing the target video according to a mute mode in the previewing and playing window of the interface; and
when the audio parameter acquired is configured to represent that the target video is not played in the previewing and playing window in mute, playing the target video according to an un-mute mode in the previewing and playing window of the interface.

12. A device for previewing video files, applied to an electronic terminal, wherein an show interface of the electronic terminal comprises at least one classification video show area, the classification video show area comprises a first show subarea and at least one second show subarea, the first show subarea is configured to show a video classification identity, the second show subarea is configured to show a video previewing window, and the video previewing window is configured to show video information corresponding to the video in the video classification; and the device for previewing video files comprises:
a processor; and
a memory for storing instructions executable by the processor;
wherein the processor is configured to:
acquire a previewing and playing position corresponding to a dynamic previewing area, and judge whether the previewing and playing position has a second show subarea; and
if the previewing and playing position is judged to have the second show subarea, play a target video in a previewing and playing window loaded at the previewing and playing position, wherein the target video is the video information corresponding to the second show subarea located at the previewing and playing position.

13. The device for previewing video files according to claim 12, wherein the processor is further configured to:
monitor a switching instruction for switching to a video previewing task.

14. The device for previewing video files according to claim 12, wherein the processor is further configured to:
when a dragging instruction for moving the previewing and playing window is detected, move the previewing and playing window according to the dragging instruction; and
record the position of the previewing and playing window when the moving is ended as a target playing position, and set the target playing position as the previewing and playing position.

15. The device for previewing video files according to claim 12, wherein the processor is further configured to:
acquire an audio parameter of the target video, wherein the audio parameter is configured to represent whether the target video is played in the previewing and playing window in mute;
then,
when determining that the audio parameter acquired is configured to represent that the target video is played in the previewing and playing window in mute, play the target video according to a mute mode in the previewing and playing window of the interface; and
when determining that the audio parameter acquired is configured to represent that the target video is not played in the previewing and playing window in mute, play the target video according to an un-mute mode in the previewing and playing window of the interface.
